(19) United States
(12) Patent Application Publication
(10) Pub. No.: US 2026/0004212 A1
(43) Pub. Date: Jan. 1, 2026

(54) GEOCENTRIC PLATFORMS FOR OBJECT EXCHANGE & ALLOCATION

(71) Applicant: KewlStreet LLC, New York, NY (US)

(72) Inventor: Eldon Scott, New York, NY (US)

(21) Appl. No.: 19/250,951

(22) Filed: Jun. 26, 2025

Related U.S. Application Data
(60) Provisional application No. 63/664,485, filed on Jun. 26, 2024.

(51) Int. Cl. G06Q 10/0631; G06F 3/04842; G06F 16/958

(52) U.S. Cl. CPC G06Q 10/06315; G06F 3/04842; G06F 16/958

(57) ABSTRACT

Methods and systems are described here for a geocentric platform for resource allocation. The geocentric platform receives a request to initiate an exchange with an agent device that includes a geographic location of the user device. The geocentric platform may initiate the exchange between the user device and the agent device. The exchange may include a request to allocate an object to the agent device. The agent device may be within a threshold distance of the geographic location of the user device. The geocentric platform may complete the exchange between the user device and the agent device. Then, the geocentric platform may identify a promoter device that is associated with the agent device and determine a resource to allocate to the promoter device based on a predetermined allocation schedule. The resource may be based on the exchange between the user device and the agent device.

### CROSS-REFERENCE TO RELATED APPLICATIONS

The present patent application claims the priority benefit of U.S. Provisional Patent Application No. 63/664,485, filed Jun. 26, 2024 and titled “Neighborhood-Centric e-Commerce Online Marketplace,” the disclosure of which is incorporated by reference herein in its entirety.

### BACKGROUND OF THE INVENTION

### 1. Field of the Disclosure

The present disclosure is generally related to a geocentric application, and more particularly relating to incorporating geographic location into geocentric user application for use in digital resource allocation.

### 2. Description of the Related Art

Small, community-oriented businesses face several disadvantages when forced to compete with e-commerce businesses, particularly when they provide equivalent or similar products or services. Despite the convenience of locally available products and services, online e-commerce platforms typically have more resources, diverse product offerings, lower prices, etc. This is often reinforced by global presence and brands which provide more efficient economies of scale and negotiating power.

Larger e-commerce businesses are further better positioned and resourced with respect to their online platforms that digitally advertise and market their products, with budgets allowing for sponsorships and preferred advertising with various platforms (e.g., social media, sports partnerships, etc.). Likewise, their scale and relationships often provide customer data and analytics which provide a distinct advantage when making business decisions and in tailoring their marketing strategies to capture market share. In an increasingly digital oriented world, small, local businesses which may have limited to no online presence can often be overlooked, particularly by tourists, despite the advantage of local geography. Likewise, they often struggle to capture local business. This often results in a customer's needs being satisfied by a large e-commerce business before considering a local agent.

There is therefore a need in the art for improved online tools and applications that incorporate geographic location into online e-commerce applications and platforms.

### SUMMARY OF THE CLAIMED INVENTION

Methods and systems are described here for a geocentric platform. The geocentric platform receives a request to initiate an exchange with an agent device. The request may be transmitted from a user device associated with a user account registered with the geocentric platform, while the agent device may be associated with an agent account registered with the geocentric platform. The request may include a geographic location of the user device. The geocentric platform may initiate the exchange between the user device and the agent device. In this example, the exchange may include a request to allocate an object to the agent device. The agent device may be within a threshold distance of the geographic location of the user device. The geocentric platform may complete the exchange between the user device and the agent device. After the completion of the exchange, the geocentric platform may query a promoter database to identify a promoter device that is associated with the agent device. The geocentric platform may then determine a resource to allocate to the promoter device based on a predetermined allocation schedule stored in a respective database. The resource may be based on the exchange between the user device and the agent device. The geocentric platform may transmit the resource to the promoter device.

Systems and methods are described herein for operating a geocentric platform. The systems include one or more processors and a non-transitory computer-readable storage medium storing instructions that, when executed by the one or more processors, cause the one or more processors to perform any of the methods as previously described.

A non-transitory computer-readable medium described herein may store instructions which, when executed by one or more processors, cause the one or more processors to perform any of the methods as previously described.

These illustrative examples are mentioned not to limit or define the disclosure, by the aid understanding thereof. Additional embodiments are discussed in the Detailed Descriptions, and further description is provided there.

### BRIEF DESCRIPTION OF THE DRAWINGS

Features, embodiments, and advantages of the present disclosure are better understood when the following detailed description is read with reference to the accompanying drawings.

FIG. 1 illustrates a block diagram of a geocentric platform according to some aspects of the present disclosure.

FIG. 2 illustrates a block diagram of a promoter database of the geocentric platform according to some aspects of the present disclosure.

FIG. 3 illustrates a block diagram of an agent database of the geocentric platform according to some aspects of the present disclosure.

FIG. 4 illustrates a block diagram of a customer database of the geocentric platform according to some aspects of the present disclosure.

FIG. 5 illustrates a flowchart of example operations for the geocentric platform according to some aspects of the present disclosure.

FIG. 6 illustrates a block diagram of a computing system capable of executing the geocentric platform according to some aspects of the present disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

This is a system for a geocentric e-commerce platform. The geocentric platform can operate as a resource to users (e.g., customers or consumers) to identify agents for obtaining specific goods or services within a certain geographic location (e.g., a neighborhood). The geocentric platform includes a network of accounts registered with the geocentric platform that are associated with users, customers, agents, promoters, any combination thereof, or the like. The network of accounts may interact to facilitate exchanges between accounts (e.g., between a user and an agent). In some examples, the network of accounts may include internal associations that are stored in a database of the geocentric platform. For example, a promoter account may be associated with one or more agent accounts, an agent account may be associated with one or more user accounts, etc.

The geocentric platform 102 may be a software program accessible via the Internet, or, in some examples, accessible via cloud network 120. Cloud network 120 may host e-commerce functionality for one or more agents of the geocentric platform 102. The geocentric platform 102 may service a plurality of geographic locations which may also be referred to as neighborhoods. A user database 104 may store data related to users of a geocentric platform 102. The users may include promoters, agents, and customers. The user database 104 may store data relating to users which may comprise any of promoters, agents, customers, etc. The stored data may comprise any of contact information, the one or more neighborhoods in which each user belongs or is assigned to, and data relating to registrations and exchanges completed on a geocentric platform 102. The user database 104 is populated and used by the promoter database 110, agent database 112, customer database 114, and exchange manager 116. For example, the user database 104 may include data as shown in TABLE I.

TABLE I
User Database 104

| User ID | User Type | Contact Information | Transactions | Registrations |
|---|---|---|---|---|
| P1045 | Promoter | John.smith@ptomotmail.com | 27 | 7 |
| V5782 | Vendor | Alice.jones@vendormarket.net | 235 | |
| C4356 | Customer | Michael.doe@shopperworld.com | 8 | |
| P2087 | Promoter | Lucy.brown@promotmail.com | 45 | 10 |
| V6290 | Vendor | Samuel.white@vendormarket.net | 328 | |
| C4821 | Customer | Jessica.green@shopperworld.com | 4 | |
| P3129 | Promoter | William.black@promotmail.com | 11 | 2 |
| V7001 | Vendor | Emily.davis@vendormarket.net | 422 | |
| C5272 | Customer | David.taylor@shopperworld.com | 15 | |
| P4156 | Promoter | Sarah.jackson@promotmail.com | 3 | 9 |

Promoters may be individuals and/or organizations which may recruit and register agents to join the geocentric platform 102. Promoters may additionally recruit customers, perform administrative tasks, contribute to advertising and/or sales campaigns, and help drive sales for the agents within their respective neighborhoods and may be associated with respective promoter devices. Agents may be businesses, typically organized into neighborhoods which correspond with a common geographic location or proximity and may be associated with respective agent devices. Customers may be individuals or organizations who may patronize one or more agents and may be associated with respective customer devices.

An incentive database 106 may store data relating to incentives paid or owed to promoters. The stored data may comprise a rate table, commission schedule, promoter agreements, and/or a history of incentives owed or paid to promoters. For example, the incentive database 106 may include data as shown below in TABLE II.

TABLE II
Incentive Database 106

| Incentive | Promoter | | |
|---|---|---|---|
| ID | ID | Incentive Criteria | Incentive |
| 0123 | P1045 | Vendor Registered | $200 |
| 5478 | P2087 | Campaign | 20% |
| | | Commission | discount |
| 9345 | P3129 | Sales Commission | $350 |
| 1290 | P1045 | Sales Commission | $500 |
| 9872 | P2087 | Vendor Registered | $150 |
| 6783 | P3129 | Campaign | 35% |
| | | Commission | discount |
| 2356 | P4156 | Vendor Registered | $250 |
| 4512 | P4156 | Sales Commission | 40% |
| | | | discount |
| 8342 | P1045 | Campaign | $450 |
| | | Commission | |
| 7125 | P3129 | Sales Commission | 25% |
| | | | discount |

The incentive database 106 is populated by the exchange manager 116 and the incentive manager 118 and is used by the incentive manager 118. Incentives may comprise monetary rewards, discounts, free items, access to limited or restricted items and/or events, etc. When a promoter device initiates a registration process with the geocentric platform 102, the user manager 108 may initiate the promoter database 110 which registers a promoter who recruits agents within a neighborhood with a promoter account. The promoter database 110 receives registration data for a promoter from the promoter device and identifies one or more neighborhoods based upon the data provided by the promoter device. The promoter device may optionally select a campaign to participate in, such as to register new agent devices on the geocentric platform 102. The promoter's data is saved to the user database 104 and the promoter device may receive one or more interested agents, from which they may select an agent associated with an agent device. The selected agent is sent to the user manager 108. When a promoter device initiates a registration process for a new agent device, the new agent device is received and the agent database 112 is initiated which registers the new agent device with an agent account. For example, the agent database 112 receives agent registration data which is verified and the agent's eligibility to join the geocentric platform 102 is confirmed (e.g., confirming at least that the agent has a business within the associated promoter's neighborhood). Eligibility may be based at least in part on the agent's physical presence within a neighborhood serviced by the geocentric platform 102. The agent's products and services may be indexed, and an online presence generated to facilitate sale of the agent's products and services. For example, the agent database 112 may generate a website associated with the agent device. The website may include an e-commerce function allowing for products and/or services to be exchanged with a customer and/or user via the website. The website may be published and indexed by search engines on the Internet and/or may be accessible through the geocentric platform 102. The data is saved to the user database 104 and the agent website is sent to the user manager 108. The information associated with the agent is stored in association with the agent account.

In some examples, a user may initiate a process to generate a customer account. The customer database 114 may be initiated to register the user with a customer account, which includes, for example, demographic information, payment information, address (e.g., neighborhood), name, phone number, email, other contact information, any combination thereof, or the like. The customer database 114 receives customer registration data from which the customer's neighborhood may be selected. The neighborhood the customer intends to patronize may alternatively be selected by the customer. The customer may be provided one or more agents within the neighborhood and/or products and services, from which the customer may select one or more agents and/or one or more products and services. In some examples, one or more products and/or services may be displayed to the customer based upon the selected agent(s) and/or a search criterion provided by the customer. The customer will select one or more products and/or services and an exchange will be completed which may comprise at least the confirmation of an order and may further comprise a financial exchange. In some examples, when a customer initiates a process to complete an exchange (e.g., allocation of resources, transmitting an object, etc.) with an agent (e.g., via the agent website), the customer database 114 may be initiated which registers a customer with a customer account and facilitates the exchange (e.g., a purchase of products and/or services) culminating in the fulfillment of the exchange by the agent within the neighborhood.

Once registered, a customer is able to facilitate an exchange with one or more agents via respective accounts (e.g., the customer account and the agent account). An exchange is performed to facilitate the allocation of resources (e.g., products, services, money, etc.) between a customer account and an agent account. At least associated customer data (e.g., associated with the customer account), associated agent data (e.g., associated with the agent account), and associated exchange data (e.g., associated products, services, values, timestamps, order numbers, receipt numbers, payment information, etc.) are saved to the user database 104 and/or a third-party database 124.

The user manager 108 may receive data associated with the exchange (e.g., associated customer data, associated agent data, and/or associated exchange data) and may transmit to the exchange manager 116. The data associated with the exchange comprises at least an agent and a total exchange amount. the exchange amount may additionally comprise an itemized list of line items. The exchange manager 116 may determine profits related to the exchange (e.g., comparison of value between a first object exchanged and a second object exchanged). For example, profits may comprise a margin, or difference between the sale price and the cost of the goods sold. The cost of goods sold may comprise the purchase price of the goods by the agent, and may further comprise any variable business costs such as shipping, inventory costs, order fulfillment costs, etc. In some embodiments, profit may be the same as revenue, or a value of an object associated with the exchange. In some embodiments, fees added to the exchange amount such as shipping, and taxes may be omitted from the profit.

The exchange manager 116 may determine a portion of an object associated with the exchange that is due to an administrator of the geocentric platform 102 (e.g., based on profit (determined by the exchange manager 116) of the exchange, based on the exchange data, a percentage of a value associated with the exchange, a percentage of a profit associated with the exchange, a fixed value set for a duration of time, a fixed value set for a number of exchanged, etc.). The first portion of the object may be provided to the administrator of a geocentric platform 102 in exchange for access to the geocentric platform 102. In some embodiments, the first portion of the object may comprise a fixed subscription amount, such as $20 per month, or $200 per year. In other embodiments, the first portion of the object may comprise a commission, such as 15% of the profit, or alternatively the total exchange amount. When using the total exchange amount to determine a commission-based first portion of the object, additional fees such as shipping and taxes may be omitted. In some embodiments, multiple first portions of the object may be required (e.g., a fixed subscription portion and an additional commission-based portion).

In some embodiments, additional first portions of the object may be required based upon other products and/or services provided to the agent and/or customers via the geocentric platform 102. For example, in some embodiments, additional fees may be collected based upon offering shipping, shipping insurance, product return services, etc. The first portion of the object may be collected directly from the agent device, or may be collected at the point of purchase, such as by reserving an amount of an exchange amount while completing the exchange. In an embodiment, an annual subscription portion may be collected directly from the agent device via a discrete exchange. In other embodiments, a fractional amount of an exchange amount, such as 15%, may be collected by the clearing house or other financial institution processing the exchange such that the amount owed to the administrator of the geocentric platform 102 is transferred to an account belonging to the administrator of the geocentric platform 102 and the remaining balance is transferred to an account belonging to the agent. In some embodiments, exchange amounts or additional fees owed to different parties may similarly be directed to each party as appropriate based upon what they are owed.

The exchange data and first portion of the object may be saved to the incentive database 106. The exchange data may comprise a value associated with the exchange, profits from exchange, etc. The platform fees may include a flat fee subscription amount, a commission amount which may comprise a percentage of the exchange amount, or alternatively the profits earned from the exchange. The collected first portion(s) of the object may be transmitted to the user manager 108. The first portion of the object may be received, and the exchange data and data associated with the first portion of the object data are saved to the incentive database 106 and/or the user manager 108.

The incentive manager 118 may receive exchange data from the user manager 108 and identifies the one or more agents associated with the exchange. The exchange data comprises at least an agent device and a total value associated with the exchange. In some examples, the exchange amount may additionally comprise an itemized list of line items. In some embodiments, first portion(s) of the object relating to the exchange may additionally be received. The incentive manager 118 may then identify one or more promoter accounts associated with the one or more agents. The promoter account may be associated with the agent account when the agent account was registered. In other embodiments, the promoter may have participated in an advertising campaign from which the exchange was a result. In some embodiments, advertising campaigns may have a fixed duration, wherein a period of sales which occur within that period may be subject to a second portion of the object due to one or more promoters. In some embodiments, the second portion of the object may be included in the first portion of the object collected from the agent device as part of the exchange. In other embodiments, the second portion of the object may be collected separately from the platform fee. Promoters may be associated with a campaign. Alternatively, promoters' involvement may be tracked via other means such as a coupon, coupon or discount code, affiliate code, or other means of identifying and/or associating a promoter with a campaign and/or exchange. In some embodiments, multiple promoters may be associated with one or more agents, campaigns, exchanges, etc.

The incentive database 106 is queried by the incentive manager 118 for data relating to determining an incentive owed to the one or more promoters and the received data is used to determine an incentive to be paid to the one or more promoters which may comprise monetary and/or non-monetary rewards. Examples of data may include a rate table, commission schedule, promoter agreement, etc. which may outline one or more incentives due to the promoter. The incentives may be monetary or may alternatively comprise other benefits which may include discounts on products at one or more agents, access to limited or restricted resources, access to events, etc. The incentive manager 118 may perform functionality to determine an incentive due to one or more promoters based upon achievement of one or more criteria (e.g., an associated agent account participates in an exchange, registering a threshold number of agents, facilitating a threshold number of exchanges between users/customers and associated agents, facilitating a specific type of exchange, etc.), based on the exchange. The promoter responsible for registering the agent and/or who contributed to the exchange is identified by the incentive database 106. The incentive database 106 is queried and the received data utilized to determine an incentive owed to the identified promoter.

In some embodiments, an incentive may comprise a second portion of the object, such as 5% of the value of the object associated with the exchange. In other embodiments, the incentive may be a flat fee based on one or more criteria, such as $1 for every exchange completed, or $5 if the exchange was completed by a new customer, or $100 if the exchange is the first completed with an agent account newly registered by the promoter. In some embodiments, the incentive may be time dependent, such as a second portion of the object of 5% of the value of the object associated with the exchange for the first three months following the registration of an agent account if the promoter is responsible for registering the agent. Likewise, an incentive may only be provided during a campaign. In other embodiments, the incentive may require other criteria be met, such as an exchange amount associated with a value over $100, a total amount of exchanges associated with a value greater than $150,000 in the first three months following the registration of an agent account registered by the promoter, etc. Criteria may additionally include quantity of exchanges, number of visitors to the agent's website, e-commerce site, geocentric platform 102 profile, physical location, etc. In some embodiments, incentives may comprise monetary rewards. In other embodiments, incentives may comprise non-monetary rewards, such as tickets or access to an event, discounts at one or more agents or on products, free products or services, etc. The incentives distributed to the one or more promoters and/or owed to the one or more promoters are saved to the incentive database 106. The determined incentive is sent to the user manager 108. The determined incentives are saved to the incentive database 106 and are sent to the user manager 108. The incentives may be transmitted to the one or more promoters accordingly.

A cloud network 120 is a distributed network of computational and data storage resources which may be available via the internet or by a local network. A cloud network 120 accessible via the internet is generally referred to as a public cloud whereas a cloud network 120 on a local network is generally referred to as a private cloud. A cloud network 120 may further be protected by encrypting data and requiring user authentication prior to accessing its resources. A third-party network 122 is comprised of one or more network resources owned by another party. For example, a third-party network 122 may refer to a non-local agent who may be affiliated with, or whose products may be sponsored by, a local agent within a neighborhood. Third-party products sponsored by local agents may be offered for sale by the local agents via a geocentric platform 102, but may not be in the local agent's inventory, but may instead be drop shipped, or purchased by the local agent on a customer's behalf. Other examples of third-party networks may comprise marketing services, financial services including clearing houses and financial institutions. A third-party database 124 stores data owned by another party. For example, a third- party database 124 may store or access data on a third-party network 122, such as a non-local agent's inventory.

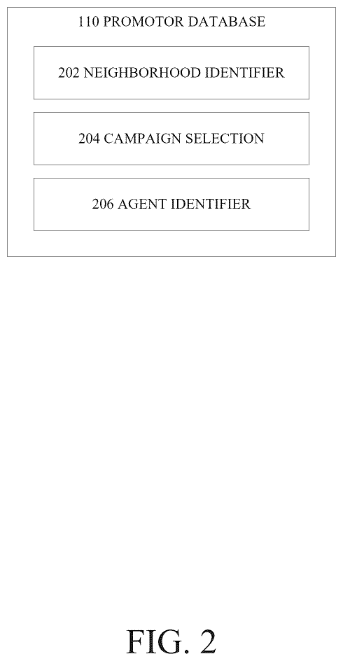

FIG. 2 illustrates a block diagram of a promoter database of the geocentric platform according to some aspects of the present disclosure. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The promoter database 110, in addition to storage capabilities, may include one or more components to perform the functionality of the promoter database 110, including, but not limited to, the neighborhood identifier 202, the campaign selection 204, and/or the agent identifier 206. As mentioned above, a promoter device may initiate a promoter registration process that may comprise transmission of personal information including a name, email address, business address, residential address, etc. The registration may comprise a password to facilitate user authentication when the promoter device accesses the geocentric platform 102. The registration may further comprise work history which may include a resume, and/or a cover letter, completed form entries, etc. A promoter's registration may be vetted by an automated system and/or a human reviewer. The promoter's neighborhood may be identified by the neighborhood identifier 202, at least based upon the promoter's location (e.g., based on an address associated with the promoter registration, a live geographic location of the promoter device, any combination thereof, or the like). The promoter's location may be their residence address, or an alternate address such as the location of the business they work for or own. In an embodiment, a promoter's neighborhood is in Southampton, NY as their residence is on Cooper Street in Southampton, NY. In an alternate embodiment, the promoter's place of business is Corwin's Jewelers at 61 Main Street in Southampton, NY and therefore their neighborhood is in Southampton, NY. The definition of a neighborhood may vary based on variables such as distance, population density, and types of businesses. For example, in highly populated urban areas, a neighborhood may comprise one or more city blocks, streets, or may be limited to a single building. In less populated areas, a neighborhood may comprise an entire city or town, or multiple towns within a region. There may be no limit to the size of a neighborhood. For example, a neighborhood may comprise an entire state. In some embodiments, a promoter may be matched to multiple neighborhoods. If the promoter's location does not correspond to an existing neighborhood, a new neighborhood may be created.

The campaign selection 204 may select one or more campaigns associated with a promoter account and/or promoter device. A campaign may comprise of at least an objective and may additionally comprise marketing and/or advertising methods, strategies, and resources, compensation incentives, etc. Objectives may be generalized, such as signing up additional businesses to the geocentric platform 102, or alternatively increasing aggregate sales of businesses within the neighborhood, increasing exchange amounts and/or the number of exchanges, increasing the number of customers, etc. Objectives may further include specific instructions or targets, such as signing up five new agents each month, or increasing average per agent sales by 10% annually, increasing the number of unique customers by 50%, etc. In some embodiments, campaigns may be optional.

The agent identifier 206 may identify one or more agents from a list of potential agents. In an embodiment, the agents are businesses located in, or with products and/or services available for purchase within the promoter's neighborhood. In some embodiments, the agents may be identified by the promoter. In other embodiments, the agents may be provided based upon a previously assembled list, or via automated means, such as by scraping web data and/or contact data for businesses, determining the business addresses and/or service area(s), and matching the businesses' locations as within the promoter's neighborhood. In some embodiments, agents may indicate interest such as by calling a phone number, sending an email, submitting an online or paper form, or otherwise reaching out to or responding to a promoter and/or marketing materials which may have been distributed by the promoter. In some examples, a promoter device may select an agent from a list of one or more potential agents. In an embodiment, the promoter device may select an agent from within the neighborhood who sells jewelry. In some embodiments, multiple agents may be selected. A selected agent may comprise an agent who has responded with interest to efforts by a promoter to register as a member of a geocentric platform 102. The selected agent may be sent to the user manager 108.

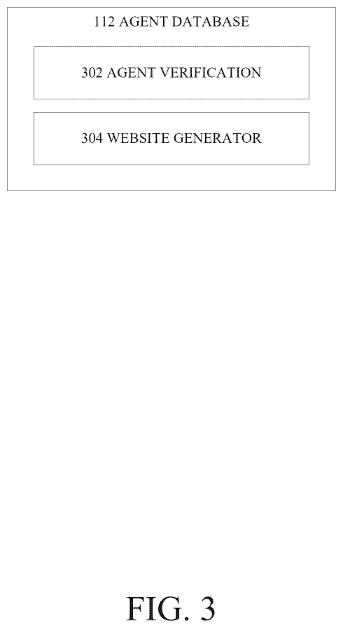

FIG. 3 illustrates a block diagram of an agent database of the geocentric platform according to some aspects of the present disclosure. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The agent database 112 may, in addition to storage capabilities, one or more components to perform the functionality of the agent database 112, including, but not limited to, an agent verification 302 and a website generator 304. The agent database 112 may receive agent registration data. Agent registration data may be associated with a new agent (e.g., being registered in association with one or more promoters) and/or agent device, and may comprise an agent address, names of one or more representatives, contact information for the one or more representatives, and may further include the type of business, size of business, such as via total revenue, exchanges, number of employees, physical footprint, etc., products and services offered, etc. The agent verification 302 may verify one or more agent details, such as location, contact information, type of business, products and services, etc. In an embodiment, confirming contact information comprising an email address by sending a message to the provided address and waiting for a response from the address. In another embodiment, confirming a phone number may comprise calling and/or sending a text message to a provided phone number and receiving an answer and/or response. Other agent details may be confirmed via comparison with a website or other content which may include social media profiles, posts, and comments such as to confirm the products and services of the agent, and the location. Likewise, verification may comprise a person such as a promoter visiting the agent location and confirming the address, products, services, etc. Based on the verifications of the agent details, the agent verification 302 may confirm agent eligibility to join the geocentric e-commerce platform. For example, agent verification 302 may confirm that the verified agent address is within the promoter's neighborhood. If the agent's location does not correspond to an existing neighborhood, a new neighborhood may be created. In other embodiments, additional eligibility criteria may apply, such as business size, type of business, such as whether it is a single location, chain, etc. The agent verification 302 may determine that the contact for the agent is authorized to represent the agent. In some embodiments, an agent may only be eligible if they accept the geocentric e-commerce platform's 102 terms of service. The agent verification 302 may generate an agent account based on the agent details once the agent is verified.

Once the agent account is generated, the website generator 304 may determine the products and services associated with the agent account. Determination of the agent's products and services may comprise uploading a list of products and/or services to the geocentric platform 102 or may alternatively comprise manual input. In other embodiments, the agent's products and/or services may be determined via web scraping, such as from third-party networks 122 and/or third-party databases 124. For example, products and services may be determined based upon consumer reviews from social media or consumer review websites. The website generator 304 may generate at least one website for marketing and/or selling products and services offered by the agent. In some embodiments, discrete websites may be created for marketing the company versus executing exchanges. Likewise, a website may comprise a profile on a geocentric platform 102 or third-party network 122. In some embodiments, an exchange website may be any of an e-commerce shop on a geocentric platform 102, third-party network 122, or a discrete, standalone website. The agent data may be saved to the user database 104. The agent data may comprise registration information, products and/or services, and may further comprise contact information including users authorized to represent and act on behalf of the agent. The agent website may also be transmitted to the user manager 108.

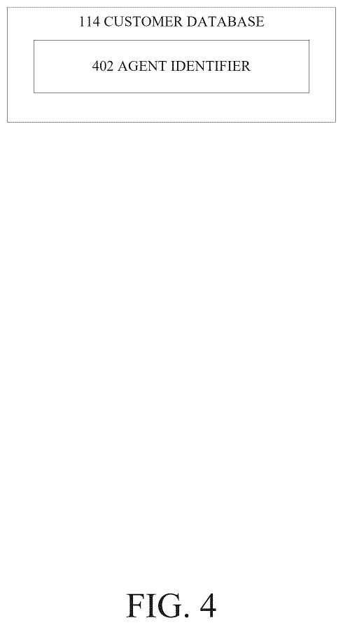

FIG. 4 illustrates a block diagram of a customer database of the geocentric platform according to some aspects of the present disclosure. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The customer database 114 may, in addition to storing data, include components to perform the functionality of the customer database 114. This may include, but is not limited to, the agent identifier 402 and/or the exchange manager 404. The customer database 114 may receive customer registration data. Customer registration data may be associated with a customer device, and may also comprise a customer address, contact information, and may further include data relating to the customer's finances for the purposes of completing an exchange, which may include evaluating and approving the customer's provided registration data to optionally extend a line of credit. Customer registration may further include the addition of secondary users, such as family members, who may be authorized to use the customer's account to complete exchanges.

The agent identifier 402 may determine the customer's neighborhood. The customer's neighborhood may be determined by comparing the customer's street address to a database and cross-referencing the address to those corresponding to a neighborhood. The agent identifier 402 may determine one or more agents that are within a threshold distance of the customer's neighborhood (and/or a current location of the customer device). If the customer's location does not correspond to an existing neighborhood, a new neighborhood may be created. In some embodiments, the customer may select a neighborhood, or define a region in which the customer would like to patronize and the nearest neighborhood may be identified based upon the information provided by the customer. Based on the determined neighborhood, the agent identifier 403 may identify one or more agents and/or agent accounts in the customer's neighborhood to the customer. The agents may be displayed via a user device which may include any computing device such as a mobile device which may comprise a mobile phone or tablet, a computer, which may comprise a desktop or notebook computer, an augmented reality (AR) or virtual reality (VR) headset, etc. The agents displayed may comprise a comprehensive list of agents within the neighborhood, or the list may be further restricted by one or more of the type of business, a product and/or service being sought by the customer, etc.

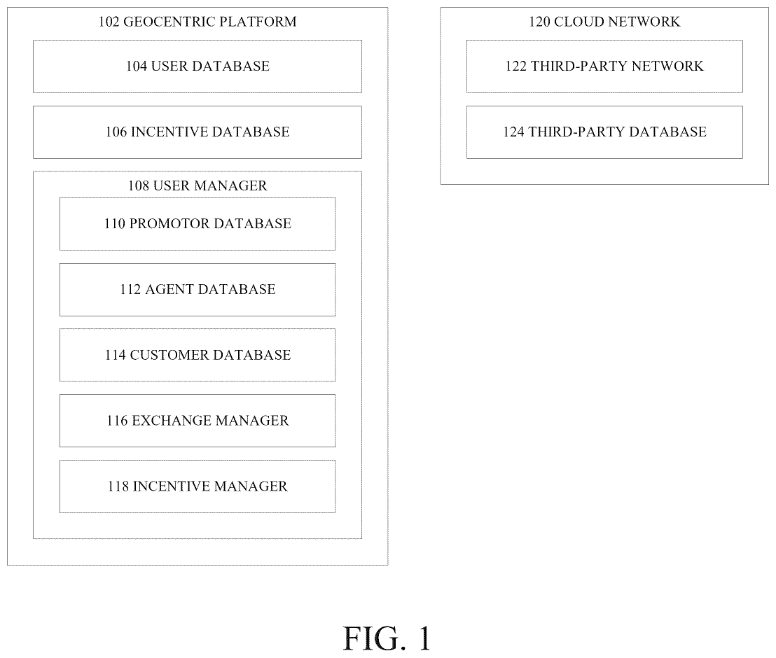

The customer device may select an agent from the one or more displayed agents. Selecting the agent may include navigating to the agent's website, which may comprise a discrete e-commerce website, or a profile or virtual store on a geocentric platform 102 or a third-party network 122. In an embodiment, selecting an agent may comprise clicking a link to the agent's e-commerce website or profile. In some embodiments, multiple agents may be selected. The customer device may select one or more products and services sold by the at least one selected agent. The selected products and/or services may be offered directly by the agent. In some embodiments, the products or services may be sponsored by the agent such that the products or services are not sold directly by the agent but may be acquired by the agent on behalf of the customer. Such products may be made available via formal relationships, such as an affiliate program with another agent or manufacturer of the product such that an inventory of the product is not maintained by the local agent, but the products may be available for sale upon request by the local agent. In alternate embodiments, no formal relationship may exist between the local agent and a second agent or a manufacturer, however the local agent may purchase and resell a product upon request of the customer. In such embodiments, the customer request may comprise executing an exchange with the item included. In some embodiments, products and/or services may not have a local agent sponsoring the sale of the product, however the products may be offered, and exchanges redirected to an external e-commerce website or agent to complete an exchange. Data pertaining to the selected item, product, service, item, resource, etc. and associated agent data may be transmitted to the exchange manager 116 (as described in FIG. 1).

The exchange manager 116 may facilitate the execution of an exchange between the customer device and the agent device. The exchange may be for one or more products and/or services between one or more agents and a customer via the geocentric platform 102. The exchange may include the allocation of one or more objects and/or resources between one or more agent devices associated with the one or more agents and/or the customer device associated with the customer. The exchange may comprise any or all of the steps of selecting one or more products and/or services being offered via the geocentric platform 102 and providing at least one method of allocation an object and/or resource (e.g., payment method, routing number, digital wallet information, digital location, etc.). A payment method may comprise an account number, credit card number, etc. In some embodiments, a payment method may comprise cash which may be exchanged in person when picking up a product in person or on delivery. An account number may be a bank account number and may additionally include a routing number. Some payment methods may utilize two factor authentication to authorize the purchase. The exchange may further require the submission of billing and/or shipping information including at least a name and address and may further include a phone number.

Completion of an exchange may include at least an acceptance by the geocentric platform 102 and/or agent device of the selected products and/or services and payment method provided by the customer device. In some examples, completion of the exchange may additionally comprise submission of the provided payment method information to a clearing house or other financial institution to process and confirm the exchange of funds. The exchange may further be fulfilled by the local agent which may include the purchase or acquisition of one or more products or services via a second agent or manufacturer. The purchased products and/or services may be delivered to an address provided by the customer or may be picked up by the customer or their representative. In some embodiments, additional fees such as shipping, taxes, etc. may be included in the exchange amount. In some embodiments, completion of an exchange may comprise completion of additional exchanges, such as for products not within the inventory of a local agent which may be purchased from another agent not within the local neighborhood. Data associated with the exchange (e.g., customer device data, agent device data, customer account, agent account, exchange data, etc.) may be transmitted to the user database 104. In some embodiments, the customer data and exchange data may additionally be saved to a third-party database 124. In some examples, the exchange data may be transmitted to the user manager 108. The exchange data may comprise at least an agent account, products and/or services purchased, and the total exchange amount.

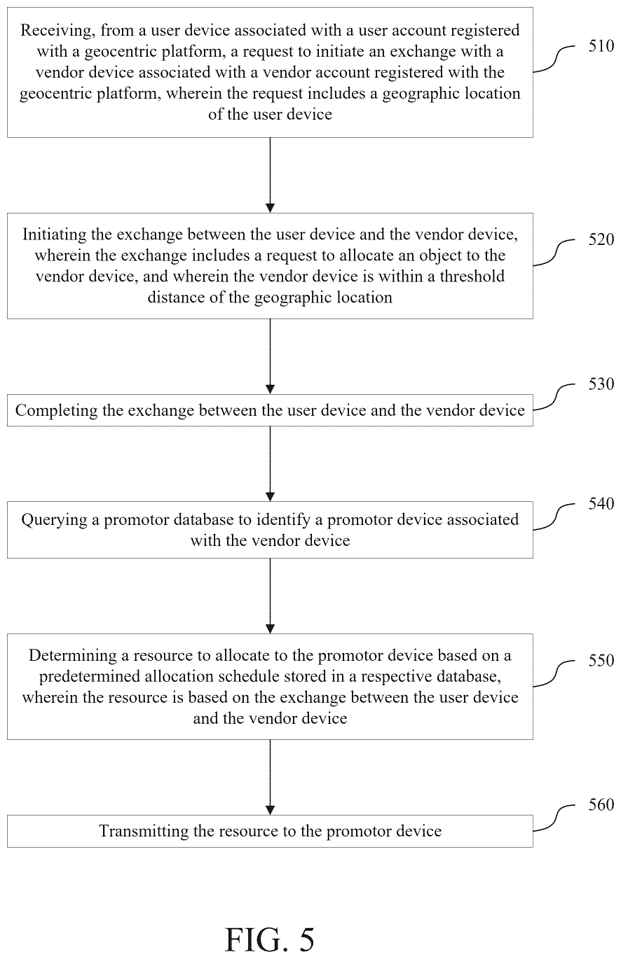

FIG. 5 illustrates a flowchart of example operations for the geocentric platform according to some aspects of the present disclosure. The example operations described herein are not to be construed as limiting and are instead intended to be an example for the operation of the geocentric platform 102. For example, the steps described herein may be performed in a different order or concurrently.

At step 510, a geocentric platform (e.g., geocentric platform 102 as described in FIG. 1) may receive, from a user device associated with a user account registered with the geocentric platform, a request to initiate an exchange with an agent device associated with an agent account registered with the geocentric platform, wherein the request includes a geographic location of the user device.

At step 520, the geocentric platform may initiate the exchange between the user device and the agent device, wherein the exchange includes a request to allocate an object to the agent device, and wherein the agent device is within a threshold distance of the geographic location.

At step 530, the geocentric platform may complete the exchange between the user device and the agent device.

At step 540, the geocentric platform may query a promoter database to identify a promoter device associated with the agent device.

At step 550, the geocentric platform may determine a resource to allocate to the promoter device based on a predetermined allocation schedule stored in a respective database, wherein the resource is based on the exchange between the user device and the agent device.

At step 560, the geocentric platform may transmit the resource to the promoter device.

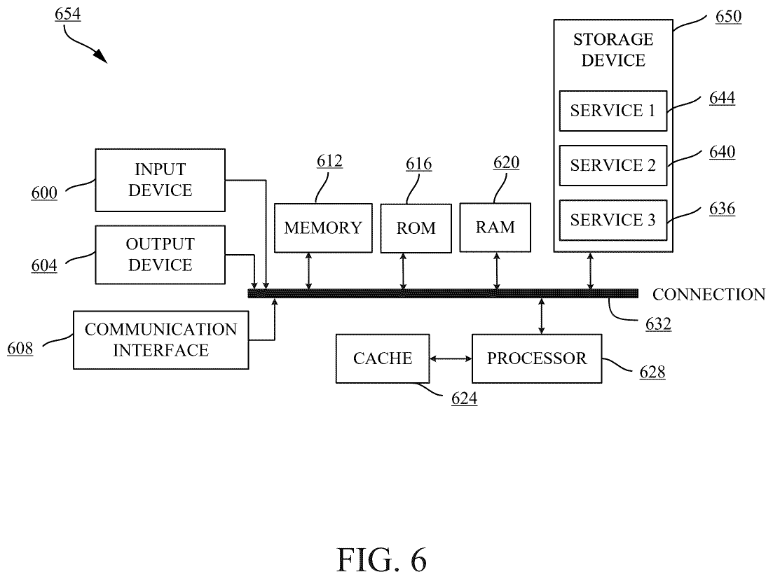

FIG. 6 illustrates an example computing device according to aspects of the present disclosure. For example, computing device 654 can implement any of the systems or methods described herein. In some instances, computing device 654 may be a component of or included within a media device. The components of computing device 654 are shown in electrical communication with each other using connection 632, such as a bus. The example computing device architecture 654 includes a processor (e.g., CPU, processor, or the like) 628 and connection 632 (e.g., such as a bus, or the like) that is configured to couple components of computing device 654 such as, but not limited to, memory 612, read only memory (ROM) 616, random access memory (RAM) 620, and/or storage device 650, to processing unit 628.

Computing device 654 can include a cache 624 of high-speed memory connected directly with, in close proximity to, or integrated within processor 628. Computing device 654 can copy data from memory 612 and/or storage device 650 to cache 624 for quicker access by processor 628. In this way, cache 624 may provide a performance boost that avoids delays while processor 628 waits for data. Alternatively, processor 628 may access data directly from memory 612, ROM 616, RAM 620, and/or storage device 650. Memory 612 can include multiple types of homogenous or heterogeneous memory (e.g., such as, but not limited to, magnetic, optical, solid-state, etc.).

Storage device 650 may include one or more non-transitory computer-readable media such as volatile and/or non-volatile memories. A non-transitory computer-readable medium can store instructions and/or data accessible by computing device 654. Non-transitory computer-readable media can include, but is not limited to magnetic cassettes, hard-disk drives (HDD), flash memory, solid state memory devices, digital versatile disks, cartridges, compact discs, random access memories (RAMs) 620, read only memory (ROM) 612, combinations thereof, or the like.

Storage device 650, may store one or more services, such as service 1 644, service 2 640, and service 3 636, that are executable by processor 628 and/or other electronic hardware. The one or more services include instructions executable by processor 628 to: perform operations such as any of the techniques, steps, processes, blocks, and/or operations described herein; control the operations of a device in communication with computing device 654; control the operations of processing unit 628 and/or any special-purpose processors; combinations therefor; or the like. Processor 628 may be a system on a chip (SOC) that includes one or more cores or processors, a bus, memories, clock, memory controller, cache, other processor components, and/or the like. A multi-core processor may be symmetric or asymmetric.

Computing device 654 may include one or more input devices 600 that may represent any number of input mechanisms, such as a microphone, a touch-sensitive screen for graphical input, keyboard, mouse, motion input, speech, media devices, sensors, combinations thereof, or the like. Computing device 654 may include one or more output devices 604 that output data to a user. Such output devices 604 may include, but are not limited to, a media device, projector, television, speakers, combinations thereof, or the like. In some instances, multimodal computing devices can enable a user to provide multiple types of input to communicate with computing device 654. Communications interface 608 may be configured to manage user input and computing device output. Communications interface 608 may also be configured to managing communications with remote devices (e.g., establishing connection, receiving/transmitting communications, etc.) over one or more communication protocols and/or over one or more communication media (e.g., wired, wireless, etc.).

Computing device 654 is not limited to the components as shown in FIG. 6. Computing device 654 may include other components not shown and/or components shown may be omitted.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored in a form that excludes carrier waves and/or electronic signals. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Some portions of this description describe examples in terms of algorithms and symbolic representations of operations on information. These operations, while described functionally, computationally, or logically, may be implemented by computer programs or equivalent electrical circuits, microcode, or the like. Furthermore, arrangements of operations may be referred to as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module can be implemented with a computer-readable medium storing computer program code, which can be executed by a processor for performing any or all of the steps, operations, or processes described.

Some examples may relate to an apparatus or system for performing any or all of the steps, operations, or processes described. The apparatus or system may be specially constructed for the required purposes, and/or it may comprise a general-purpose computing device selectively activated or reconfigured by a computer program stored in memory of computing device. The memory may be or include a non-transitory, tangible computer readable storage medium, or any type of media suitable for storing electronic instructions, which may be coupled to a bus. Furthermore, any computing systems referred to in the specification may include a single processor or multiple processors.

While the present subject matter has been described in detail with respect to specific examples, it will be appreciated that those skilled in the art, upon attaining an understanding of the foregoing, may readily produce alterations to, variations of, and equivalents to such embodiments. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

For clarity of explanation, in some instances the present disclosure may be presented as including individual functional blocks including functional blocks comprising devices, device components, steps or routines in a method embodied in software, or combinations of hardware and software. Additional functional blocks may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual examples may be described herein as a process or method which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not shown. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

Devices implementing the methods and systems described herein can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. The program code may be executed by a processor, which may include one or more processors, such as, but not limited to, one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A processor may be a microprocessor; conventional processor, controller, microcontroller, state machine, or the like. A processor may also be implemented as a combination of computing components (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein. Functionality described herein also can be embodied in peripherals or add-in cards. Such functionality can also be implemented on a circuit board among different chips or different processes executing in a single device, by way of further example.

In the foregoing description, aspects of the disclosure are described with reference to specific examples thereof, but those skilled in the art will recognize that the disclosure is not limited thereto. Thus, while illustrative examples of the disclosure have been described in detail herein, it is to be understood that the inventive concepts may be otherwise variously embodied and employed, and that the appended claims are intended to be construed to include such variations. Various features and aspects of the above-described disclosure may be used individually or in any combination. Further, examples can be utilized in any number of environments and applications beyond those described herein without departing from the broader spirit and scope of the disclosure. The disclosure and figures are, accordingly, to be regarded as illustrative rather than restrictive.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or media devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method for geographic-based resource allocation, the method comprising:
receiving a request sent over a communication network from a user device associated with a user account registered with a geocentric platform, the request concerning initiation of an exchange with an agent device associated with an agent account registered with the geocentric platform, wherein the request includes a geographic location of the user device;
initiating the exchange between the user device and the agent device, wherein the exchange includes a request to allocate an object to the agent device, and wherein the agent device is within a threshold distance of the geographic location;
querying a promoter database to identify a promoter device associated with the agent device;
determining a resource to allocate to the promoter device based on a predetermined allocation schedule stored in a respective database, wherein the resource is based on the exchange between the user device and the agent device; and
initiating transmission of the determined resource to the promoter device.

2. The computer-implemented method of claim 1, further comprising:
receiving a registration request from the promoter device to register the agent device with the geocentric platform; and
generating the agent account based on the registration request, wherein the agent account is stored in association with the promoter device.

3. The computer-implemented method of claim 1, further comprising:
determining a first portion of the object to allocate to a device associated with the geocentric platform; and
initiating transmission of the first portion of the object to the device.

4. The computer-implemented method of claim 1, wherein the geocentric platform is associated with a plurality of agent accounts associated with respective agent devices, wherein the plurality of agent accounts include the agent account, and further comprising:
generating individual agent websites for each of the plurality of agent accounts; and
enabling the individual agent websites to be accessed by the user device, wherein the individual agent websites facilitate exchanges between an associated agent account and the user device.

5. The computer-implemented method of claim 4, further comprising:
receiving input from an interactive user interface of the user device indicating a selection of an agent website; and
generating a display of the selected agent website for the interactive user interface of the user device.

6. The computer-implemented method of claim 1, wherein the agent device is associated with a defined neighborhood based on at least one of the geographic location of the agent device, an address associated with the agent account of the agent device, and the promoter device.

7. The computer-implemented method of claim 1, wherein the promoter device is associated with a defined neighborhood based on at least one of the geographic location of the promoter device, a residential address associated with a promoter account of the promoter device, and a work address associated with the promoter account of the promoter device.

8. A system for geographic-based resource allocation, the system comprising:
one or more processors;
a communication interface that communicates over a communication network, wherein the communication interface receives a request sent from a user device associated with a user account registered with a geocentric platform, the request concerning initiation of an exchange with an agent device associated with an agent account registered with the geocentric platform, wherein the request includes a geographic location of the user device; and
a memory storing instructions executable by the one or more processors to:
initiate the exchange between the user device and the agent device, wherein the exchange includes a request to allocate an object to the agent device, and wherein the agent device is within a threshold distance of the geographic location;
query a promoter database to identify a promoter device associated with the agent device;
determine a resource to allocate to the promoter device based on a predetermined allocation schedule stored in a respective database, wherein the resource is based on the exchange between the user device and the agent device; and
initiate transmission of the determined resource to the promoter device.

9. The system of claim 8, wherein the communication interface receives a registration request from the promoter device to register the agent device with the geocentric platform; and wherein the processors execute further instructions to generate the agent account based on the registration request, wherein the agent account is stored in association with the promoter device.

10. The system of claim 8, wherein the processors execute further instructions to determine a first portion of the object to allocate to a device associated with the geocentric platform and initiates transmission of the first portion of the object to the device.

11. The system of claim 8, wherein the geocentric platform is associated with a plurality of agent accounts associated with respective agent devices, wherein the plurality of agent accounts include the agent account, and wherein the processors execute further instructions to
generate individual agent websites for the plurality of agent accounts; and
enable the individual agent websites to be accessed by the user device, wherein the individual agent websites facilitate exchanges between an associated agent account and the user device.

12. The system of claim 11, wherein the communication interface further receive input from an interactive user interface of the user device indicating selection of an agent website, and wherein the processors execute further instructions to generate a display of the selected agent website for the interactive user interface of the user device.

13. The system of claim 8, wherein the agent device is associated with a defined neighborhood based on at least one of the geographic location of the agent device, an address associated with the agent account of the agent device, and the promoter device.

14. The system of claim 8, wherein the promoter device is associated with a defined neighborhood based on at least one of the geographic location of the promoter device, a residential address associated with a promoter account of the promoter device, and a work address associated with the promoter account of the promoter device.

15. A non-transitory computer-readable storage medium, the non-transitory computer-readable storage medium including instructions executable by one or more processors to perform a method for geographic-based resource allocation, the method comprising:
receiving a request sent over a communication network from a user device associated with a user account registered with a geocentric platform, the request concerning initiation of an exchange with an agent device associated with an agent account registered with the geocentric platform, wherein the request includes a geographic location of the user device;
initiating the exchange between the user device and the agent device, wherein the exchange includes a request to allocate an object to the agent device, and wherein the agent device is within a threshold distance of the geographic location;
querying a promoter database to identify a promoter device associated with the agent device;
determining a resource to allocate to the promoter device based on a predetermined allocation schedule stored in a respective database, wherein the resource is based on the exchange between the user device and the agent device; and
initiating transmission of the determined resource to the promoter device.

16. The non-transitory computer-readable storage medium of claim 15, further comprising instructions executable to:
receive a registration request from the promoter device to register the agent device with the geocentric platform; and
generate the agent account based on the registration request, wherein the agent account is stored in association with the promoter device.

17. The non-transitory computer-readable storage medium of claim 15, further comprising instructions executable to:
determine a first portion of the object to allocate to a device associated with the geocentric platform; and
initiate transmission of the first portion of the object to the device.

18. The non-transitory computer-readable storage medium of claim 15, wherein the geocentric platform is associated with a plurality of agent accounts associated with respective agent devices, wherein the plurality of agent accounts include the agent account, and further comprising instructions executable to:
generate individual agent websites for each of the plurality of agent accounts; and
enable the individual agent websites to be accessed by the user device, wherein the individual agent websites facilitate exchanges between an associated agent account and the user device.

19. The non-transitory computer-readable storage medium of claim 18, further comprising instructions executable to:
receiving input from an interactive user interface of the user device indicating a selection of an agent website; and
generating a display of the selected agent website for the interactive user interface of the user device.

20. The non-transitory computer-readable storage medium of claim 15, wherein the agent device is associated with a defined neighborhood based on at least one of the geographic location of the agent device, an address associated with the agent account of the agent device, and the promoter device.
